(19) United States
(12) Patent Application Publication
(10) Pub. No.: US 2015/0298958 A1
(43) Pub. Date: Oct. 22, 2015

(54) WATER DISPENSER

(71) Applicant: Kabushiki Kaisha Cosmo Life, Hyogo (JP)

(72) Inventor: Yoshinori ORITA, Hyogo (JP)

(21) Appl. No.: 14/437,840

(22) PCT Filed: Sep. 27, 2013
(86) PCT No.: PCT/JP2013/076337

§ 371 Date: Apr. 23, 2015

(30) Foreign Application Priority Data
Oct. 25, 2012 (JP) 2012-235455

(51) Int. Cl. B67D 3/00

(52) U.S. Cl. CPC B67D 3/0035; B67D 3/0009; B67D 3/0022

(57) ABSTRACT

A water dispenser is provided in which a holder is arranged at a lower level, a cold water tank is arranged at a higher level, and a raw water supply line is sterilized. The water dispenser is provided with a circulation line, upper and lower switch valves, and a heater for sterilization. The circulation line is connected at its top and bottom ends to the raw water supply line in the vicinity of the cold water tank, and in the vicinity of the holder, respectively. The switch valves are provided at upper and lower branch points, respectively. The switch vales are movable between a normal operation position in which a raw water container and the cold water tank communicate with the raw water supply line, and a sterilization operation position in which the raw water supply line communicates with the circulation line.

### TECHNICAL FIELD

The present invention relates to a water dispenser in which drinking water is supplied from a replaceable raw water container.

### BACKGROUND ART

Since interest in the safety of water or in health is growing these days, the number of water dispensers used in ordinary homes is increasing.

As disclosed in the below-identified patent documents 1 and 2, a water dispenser is known which includes, a holder arranged at a lower level and configured to hold a replaceable raw water container filled with drinking water, a cold water tank which is arranged at a higher level, and in which drinking water is cooled, and a raw water supply line extending upwardly and downwardly between the holder and the cold water tank, and including a tubular joint member provided at the bottom end portion of the raw water supply line, and configured to be inserted into the mouth portion of the raw water container with the raw water container held by the holder.

In such a water dispenser, as a pump attached to the raw water supply line operates, drinking water in the raw water container placed on the holder is supplied to the cold water tank through the raw water supply line so as to be cooled in the cold water tank, and the cooled drinking water is provided to the user.

In the water dispenser disclosed in patent document 1, unlike general water dispensers in which a holder is arranged at a high level and a cold water tank is arranged at a lower level, a holder for holding a raw water container is arranged at a lower level and a cold water tank is arranged at a higher level. Therefore, it is not necessary to lift a raw water container up and down for replacement, and it is possible to easily replace a raw water container.

### PRIOR ART DOCUMENT(S)

### Patent Document(s)

Patent document 1: Japanese Patent No. 4802299

Patent document 2: Japanese Unexamined Patent Application Publication No. 2001-153523

### SUMMARY OF THE INVENTION

### Problems To Be Solved by the Invention

Since drinking water is usually normal-temperature in a raw water container, normal-temperature drinking water suitable for the proliferation of general germs flows in a raw water supply.

Therefore, in case a water dispenser is used for a long period of time, when a joint member of a raw water supply line is inserted into or out of the mouth portion of a raw water container, a small number of germs might go into and proliferate in the raw water supply line. Also, in case a raw water supply line is made of material through which air permeates, such as silicon rubber, germs in air similarly might go into and proliferate in the raw water supply line.

Especially in the water dispenser disclosed in patent document 1, a raw water container is placed on a holder arranged at a lower level in the upside down position, i.e., with the bottom portion of the container directed upwardly, thus making long the entire length of a raw water supply line arranged between the mouth portion thereof and a cold water tank arranged at a higher level. As a result thereof, germs are likely to proliferate in the raw water supply line.

It is an object of the present invention to enable a raw water supply line extending between a holder and a cold tank to be sterilized in a water dispenser in which the holder is arranged at a lower level, and the cold water tank is arranged at a higher level.

### Means for Solving the Problems

In order to achieve the above object, the present invention provides a water dispenser comprising a holder arranged at a lower level, a cold water tank arranged at a higher level, and a raw water supply line which extends between the holder and the cold water tank, and to which a pump is attached, wherein the water dispenser further comprises a circulation line, upper and lower switch valves, and a heater for sterilization.

The circulation line has a top end portion connected to an upper branch point of the raw water supply line in the vicinity of the cold water tank, and a bottom end portion connected to a lower branch point of the raw water supply line in the vicinity of the holder.

The upper and lower switch valves are provided at the upper and lower branch points, respectively. The switch valves are movable between a normal operation position in which the raw water container and the cold water tank communicate with the raw water supply line, while the raw water supply line and the circulation line are disconnected from each other, and a sterilization operation position in which the raw water supply line communicates with the circulation line, while the raw water container and the cold water tank are disconnected from the raw water supply line.

When the upper and lower valves are in the sterilization operation position, the heater for sterilization is configured to heat water circulated by the pump between the raw water supply line and the circulation line until the water reaches a sterilization temperature.

While the upper and lower switch valves are in the normal operation position, the raw water container and the cold water tank communicate with the raw water supply line. As a result thereof, drinking water is supplied by the pump from the raw water container into the cold water tank through the raw water supply line, and is provided to the user.

While the upper and lower switch valves are in the sterilization operation position, water is circulated by the pump between the raw water supply line and the circulation line, and heated by the heater for sterilization so as to be made hot water, thereby sterilizing the interior of the raw water supply line by hot water.

The water dispenser according to the present invention may further comprise a hot water tank which is arranged at a higher level than the holder and at a lower level than the cold water tank, and to which a heater is attached which heats drinking water supplied from the cold water tank. Water heated in the hot water tank is provided to the user. In this arrangement, it is preferable that the circulation line is interrupted by the hot water tank, and that the heater attached to the hot water tank is used as the heater for sterilization.

Also, the water dispenser according to the present invention may further comprise a hot water discharge line extending from the top portion of the hot water tank, and arranged such that only when the hot water tank is filled with water, water can be discharged from the hot water tank through the hot water discharge line, and a drain discharge line extending from the bottom portion of the hot water tank, and configured to be opened and closed such that when the drain discharge line is opened, drinking water in the hot water tank can be completely discharged through the drain discharge line. In this arrangement, it is more preferable that the circulation line is divided into an upper half portion and a lower half portion, and that the bottom end of the upper half portion is connected to the drain discharge line, and the top end of the lower half portion is connected to the hot water discharge line. Alternatively, in this arrangement, it is preferable that the circulation line is not connected to the hot water tank, that the heater for sterilization is provided separately from the heater attached to the hot water tank at a portion of the raw water supply line between the upper and lower branch points or at a portion of the circulation line between the upper and lower branch points, and that the heater for sterilization is configured to generate heat, when the upper and lower switch valves are in the sterilization operation position, and stop generating heat, when the upper and lower switch valves are in the normal operation position.

It is preferable that the water dispenser according to the present invention further comprises an ultraviolet ray-emitting device configured to apply an ultraviolet ray to the interior of the joint member of the raw water supply line so as to obtain sterilization effect.

### Effects of the Invention

Since the water dispenser according to the present invention is configured as described above, it is possible to sterilize the interior of the law water supply line by hot water so that the raw water supply line is kept hygienic.

### BRIEF DESCRIPTION OF THE DRAWINGS

FIG. 1 is a sectional view of a water dispenser according to an embodiment of the present invention as seen from the lateral side.

FIG. 2 is a sectional view of a main portion of the water dispenser according to the embodiment of the present invention.

FIG. 3 is a sectional view of the water dispenser with a large amount of water remaining in a raw water container.

FIG. 4 is a sectional view of the water dispenser with a small amount of water remaining in the raw water container.

FIG. 5 is a sectional view of the water dispenser with no water remaining in the raw water container.

FIG. 6 is a sectional view of the water dispenser illustrating a sterilization operation mode.

FIG. 7 is a block diagram of the water dispenser according to the embodiment of the present invention.

FIG. 8 is a flow chart illustrating how control is performed by a control device.

FIG. 9 is a sectional view of a water dispenser according to another embodiment of the present invention as seen from the lateral side.

FIG. 10 is a sectional view of a water dispenser according to another embodiment of the present invention as seen from the lateral side.

### BEST MODE FOR CARRYING OUT THE INVENTION

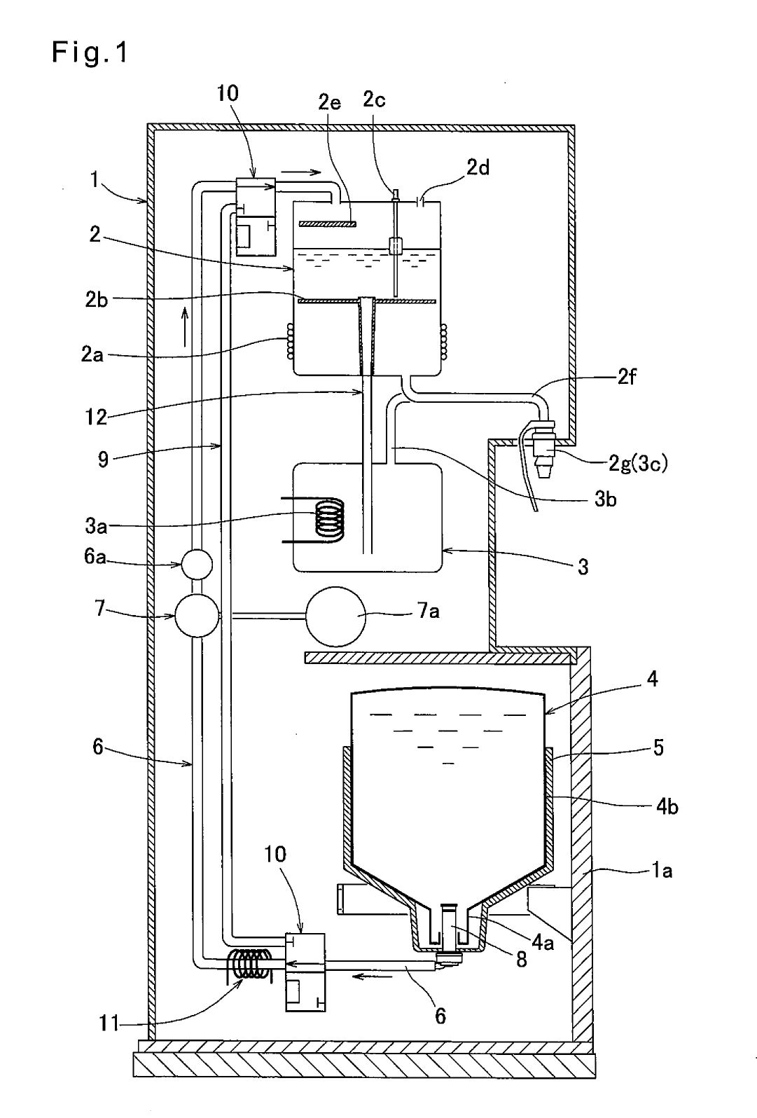

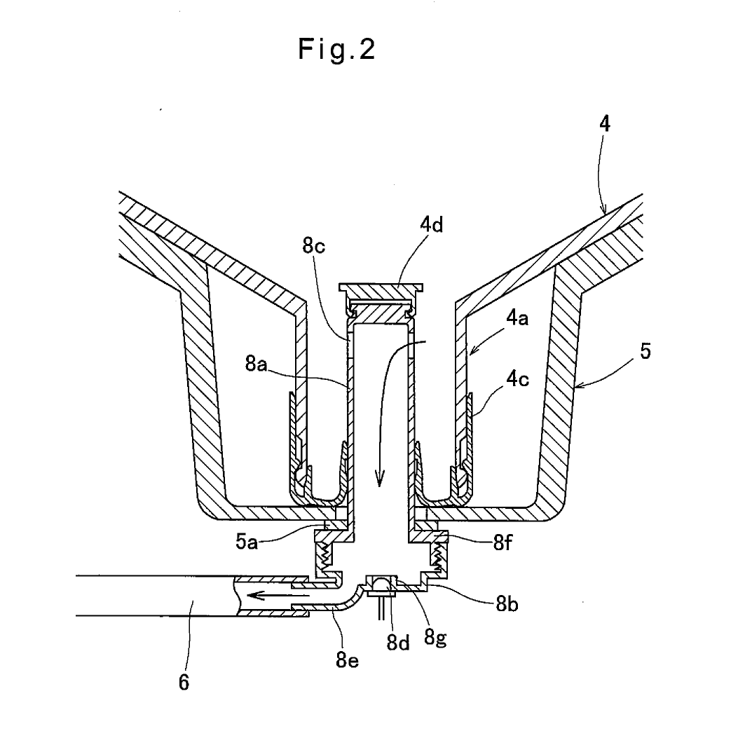

The embodiments of the present invention are now described with reference to the drawings. The water dispenser according to the embodiment illustrated in FIGS. 1 and 2 includes a casing 1, a cold water tank 2 and a hot water tank 3 which are arranged inside of the casing 1, a holder 5 for holding a replaceable raw water container 4, a raw water supply line 6 through which the interior of the cold water tank 2 communicates with the interior of the raw water container 4 held by the holder 5, and a pump 7 attached to the raw water supply line 6.

The water dispenser further includes a joint member 8 provided at the bottom end of the raw water supply line 6 and having a built-in ultraviolet ray-emitting device 8d, a circulation line 9 branching off from the raw water supply line 6 at two points, upper and lower switch valves 10 provided at the respective branch points at which the circulation line 9 branches off from the raw water supply line 6, and a heater 11 for sterilization.

The raw water container 4 is held by the container holder 5 with a mouth portion 4a of the container 4 directed downwardly, i.e., in the upside down position. The raw water container 4 has a trunk portion 4b flexibly formed such that the container 4 shrinks up to a predetermined limit as the amount of water remaining in the container 4 decreases. The raw water container 4 may be formed by blow molding of, for example, polyethylene terephthalate (PET) resin or polyethylene (PE) resin. The maximum volume of the raw water container 4, i.e. the maximum amount of drinking water the container 4 can hold, is about 8 to 20 liters.

A cap 4c having a built-in valve 4d is attached to an opening of the mouth portion 4a of the raw water container 4. In a normal state, the opening of the mouth portion 4a is closed by this valve 4d, thereby preventing drinking water from leaking out of the raw water container 4.

In order to make it possible to easily replace the raw water container 4, the holder 5, arranged in the lower portion of the casing 1, is attached to a slide table la provided in the lower portion of the casing 1 and supported so as to be slidable in a horizontal direction, thereby making it possible to move the holder 5 into and out of the casing 1 through the front side of the casing 1.

As illustrated in FIG. 2, the joint member 8 is water-tightly fixed to the bottom portion of the container holder 5 through a seal member 5a so as to be removably inserted into the mouth portion 4a of the raw water container 4 with the container 4 held by the holder 5.

The joint member 8 includes a tubular hollow insertion portion 8a extending in the vertical direction and having an opening at its bottom portion on which a flange 8f is provided, and a dish-shaped base portion 8b having a top opening. By overlapping the flange 8f provided on the bottom portion of the insertion portion 8a and the open top portion of the base portion 8b, and joining them together by an appropriate means, such as by threaded engagement, the insertion portion 8a and the base portion 8b are made integral with each other such that an internal space through which water can flow is defined in the joint member 8.

As illustrated in FIG. 2, when the insertion portion 8a of the joint member 8 is inserted into the mouth portion 4a of the raw water container 4, the valve 4d of the cap 4c is fitted onto the distal end of the insertion portion 8a, and is pushed into the raw water container 4. As a result thereof, as illustrated by the arrow in FIG. 2, drinking water contained in the raw water container 4 can flow into the internal space of the joint member 8 from the opening of the mouth portion 4a through passage holes 8c formed in the insertion portion 8a.

A substantially cylindrical mounting portion 8g is provided at the bottom center of the internal space of the joint member 8, namely, at the bottom center of the base portion 8b. The mounting portion 8g has the ultraviolet ray-emitting device 8d mounted thereon which is configured to emit ultraviolet rays, and which may comprise an LED light, etc. Waterproof treatment is appropriately performed to the ultraviolet ray-emitting device 8d, for example, by filling a gap between the device 8d and the mounting portion 8g of the base portion 8b with resin. When the ultraviolet ray-emitting device 8d starts to operate, the internal space of the joint member 8 is sterilized by ultraviolet rays the device 8d emits.

A pipe-shaped connection port 8e is provided at the bottom portion of the base portion 8b in the vicinity of the ultraviolet ray-emitting device 8d, and the raw water supply line 6 is connected at its end on the side of the raw water container 4 (bottom end) to the connection port 8e. As a result thereof, drinking water that has flowed into the internal space of the joint member 8 through the passage hole 8c can further flow into the raw water supply line 6 through the connection port 8e.

The pump 7 and a flow sensor 6a are attached to the middle portion of the raw water supply line 6 extending in the vertical direction. The pump 7 may be, for example, a gear pump in which a pair of gears meshing with each other rotate so as to pump out drinking water. When the pump 7 is activated, drinking water in the raw water supply line 6 is transferred upwardly from the side of the raw water container 4 toward the cold water tank 2. While the pump 7 is operating, when the raw water supply line 6 has reached the state in which no drinking water is flowing in the line 6, the flow sensor 6a can detect this state.

The cold water tank 2, arranged at a higher level than the holder 5 in the interior of the casing 1, has a cooler 2a attached thereto which cools drinking water stored in the tank 2. Also, the cold water tank 2 is provided in the interior thereof with a baffle plate 2b which is arranged substantially in the horizontal direction and which partitions the internal space of the tank 2 into upper and lower portions. The cooler 2a is arranged on the outer periphery of the lower portion of the cold water tank 2, and keeps drinking water stored in the tank 2 under the baffle plate 2b at a low temperature (about 5 degrees Celsius).

The cold water tank 2 has a water level sensor 2c attached thereto which detects the water level of drinking water stored in the tank 2. When the water level sensor 2c detects that the water level of drinking water has fallen, the pump 7 is activated so that drinking water is supplied from the raw water container 4 to the cold water tank 2, according to how much the water level of drinking water has fallen.

When drinking water is supplied from the raw water container 4 to the cold water tank 2, the baffle plate 2b prevents low-temperature drinking water cooled by the cooler 2a and stored in the lower portion of the tank 2 from mixing with and being stirred by normal-temperature drinking water supplied from the container 4 to the tank 2.

The cold water tank 2 is provided in the top surface thereof with an air intake port 2d. Air is introduced into the cold water tank 2 through the air intake port 2d according to how much the water level of drinking water has fallen in the tank 2, so that the interior of the tank 2 is maintained at atmospheric pressure. A filter, an ozone sterilization device, or an ultraviolet ray sterilization device may be attached to the air intake port 2d so that air introduced into the cold water tank 2 is kept hygienic.

The raw water supply line 6 is connected at its end on the side of the cold water tank 2 (top end) to the upper portion of the tank 2. Right under this connection portion, the cold water tank 2 is provided with a substantially horizontally extending diffusing plate 2e configured to diffuse the flow of drinking water supplied through the raw water supply line 6 to the cold water tank 2 before the supplied water reaches the surface of drinking water which has been already stored in the tank 2.

The cold water tank 2 has a cold water discharge line 2f of which one end portion (inner end portion) is connected to the bottom of the tank 2 and through which low-temperature drinking water stored in the bottom portion of the tank 2 is discharged outside. The cold water discharge line 2f is provided at the other end portion (outer end portion) thereof with a cold water cock 2g which is arranged on the front side of the casing 1 and which is operable from the outside of the casing 1. By opening the cold water cock 2g, low-temperature drinking water can be discharged from the cold water tank 2 into a cup, etc. The volume of the cold water tank 2 is smaller than the volume of the raw water container 4, and is about 2 to 4 liters.

A tank connection line 12 which extends in the vertical direction and through which the cold water tank 2 and the hot water tank 3 are connected together has a top end opening at the center of the baffle plate 2b. Through the tank connection line 12, drinking water is introduced from the cold water tank 2 into the hot water tank 3. A check valve may be mounted inside of the tank connection line 12 so as to prevent drinking water from flowing into the cold water tank 2 from the hot water tank 3.

The hot water tank 3, arranged at a higher level than the holder 5 and at a lower level than the cold water tank 2 in the interior of the casing 1, has a heater 3a attached to the internal space thereof which heats drinking water stored in the tank 3 and keeps it at a high temperature (about 90 degrees Celsius).

Since the tank connection line 12 has a bottom end opening at a position lower than the heater 3a in the hot water tank 3, cooled drinking water introduced into the hot water tank 3 from the cold water tank 2 is heated by the heater 3a, and the heated water rises in the tank 3.

The hot water tank 3 has a hot water discharge line 3b of which one end portion (inner end portion) is connected to the top of the tank 3 and through which, when the tank 3 is substantially filled with drinking water, high-temperature drinking water stored in the upper portion of the tank 3 is discharged outside. The hot water discharge line 3b is provided at the other end portion (outer end portion) thereof with a hot water cock 3c which is arranged on the front side of the casing 1 and which is operable from the outside of the casing 1. By opening this hot water cock 3c, high-temperature drinking water can be discharged from the hot water tank 3 into a cup, etc. When drinking water is discharged from the hot water tank 3, since drinking water equal in amount to the discharged drinking water flows through the tank connection line 12 into the hot water tank 3 from the cold water tank 2, the tank 3 is always filled with drinking water. The volume of the hot water tank 3 is smaller than the volume of the raw water container 4, and is about 1 to 2 liters.

The circulation line 9 is connected at its top and bottom ends to the raw water supply line 6 in the vicinity of the cold water tank 2 and in the vicinity of the holder 5, respectively. Namely, said upper and lower connection portions are upper and lower branch points at which the circulation line 9 branches off from the raw water supply line 6.

It is not necessarily required that the upper and lower branch points be located at the positions specifically illustrated in the figures, as long as the upper and lower branch points are considered to be located “in the vicinity of” the cold water tank 2 and the holder 5, respectively, within the usual meaning of this term. For example, the upper branch point may be located such that the distance from the top end of the raw water supply line 6 (end of the line 6 on the side of the cold water tank 2) is ⅛ or less of the entire length of the line 6, and the lower branch point may be located such that the distance from the bottom end of the line 6 (end of the line 6 on the side of the holder 5) is ⅛ or less of the entire length of the line 6.

In order to allow for the slide operation of the slide table la by which the holder 5 is supported, it is preferable that the raw water supply line 6 and the circulation line 9 are each made of a flexible material. For example, the raw water supply line 6 and the circulation line 9 may be each a silicon tube, a fluororesin tube, or a fluororubber tube.

When the water dispenser is in use, the flow of drinking water can be switched by the switch valves 10, provided at the upper and lower branch points, respectively, at which the circulation line 9 branches off from the raw water supply line 6.

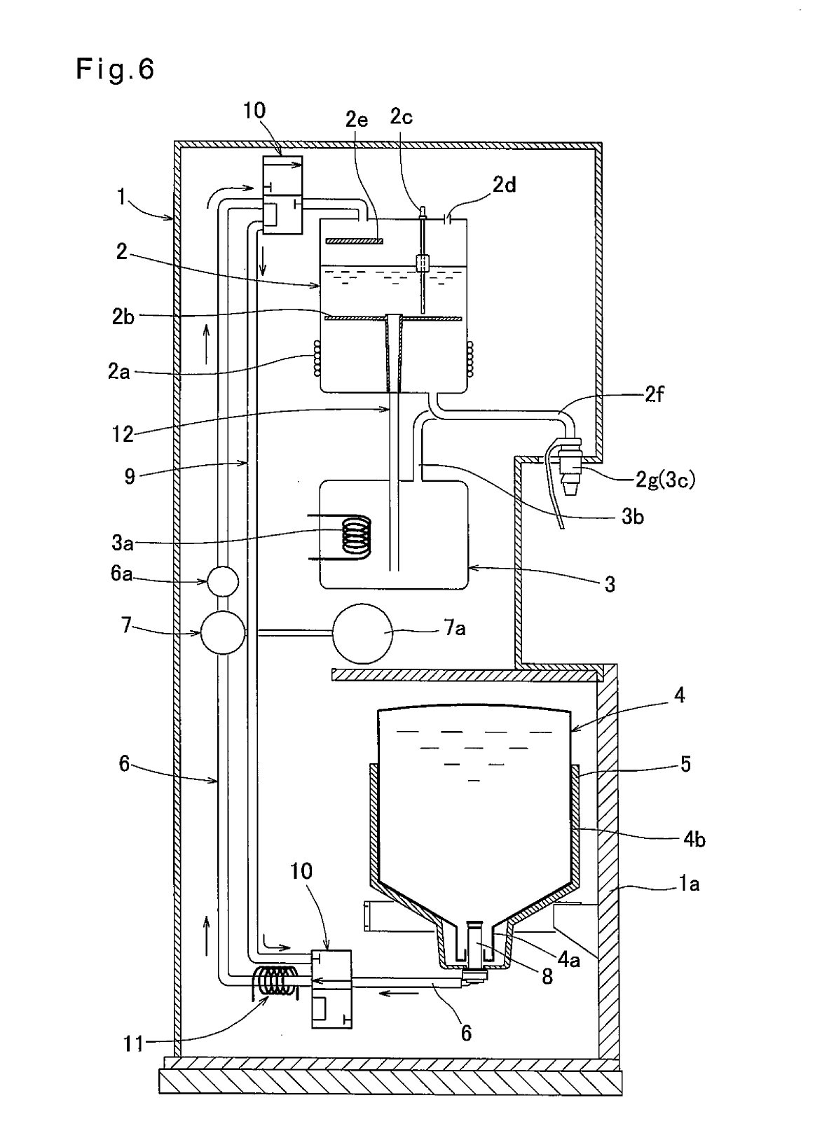

Namely, the upper and lower switch valves 10 can switch the flow of drinking water by moving, in synchronization with each other, between a normal operation position (“off” mode) in which, as illustrated in FIG. 1, the raw water container 4, the raw water supply line 6, and the cold water tank 2 communicate with each other, while the circulation line 9 is disconnected from the raw water supply line 6, and a sterilization operation position (“on” mode) in which, as illustrated in FIG. 6, both the raw water container 4 and the cold water tank 2 are disconnected from the raw water supply line 6, with the circulation line 9 communicating with the raw water supply line 6.

The upper and lower switch valves 10 shown are each constituted by a single valve. However, instead of such valves 10, switch valve assemblies may be used each constituted by a plurality of valves and having the same function as the upper switch valve 10 or the lower switch valve 10.

The heater 11 for sterilization is attached to the raw water supply line 6. The heater 11 is configured to be turned on and generate heat when the switch valves 10 are in the sterilization operation position (“on” mode), and to be turned off and stop generating heat when the switch valves 10 are in the normal operation position (“off” mode). In the figures, the heater 11 for sterilization is attached to the portion of the raw water supply line 6 in the vicinity of the lower branch point and between the upper and lower branch points. However, the heater 11 for sterilization may be attached to any portion of the raw water supply line 6 or of the circulation line 9.

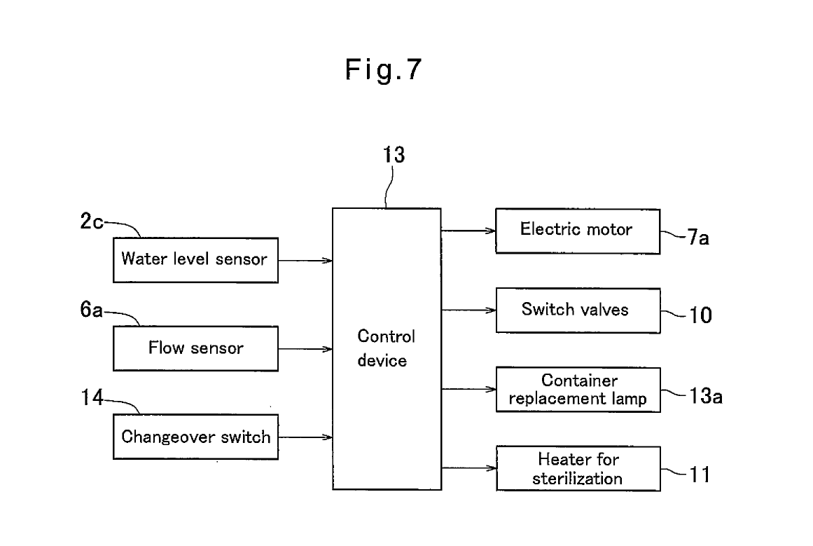

The pump 7, the switch valves 10, and the heater 11 for sterilization are controlled by a control device 13 illustrated in FIG. 7. A signal indicating the water level of drinking water stored in the cold water tank 2 is input to the control device 13 from the water level sensor 2c, a signal indicating the amount of drinking water flowing in the raw water supply line 6 is input to the device 13 from the flow sensor 6a, and a signal is input to the device 13 from a changeover switch 14.

The changeover switch 14 is manually operated to move the switch valves 10 between the normal operation position (“off” mode) and the sterilization operation position (“on” mode), and is arranged at the front of the casing 1. When the changeover switch 14 is off, the switch valves 10 and the heater 11 for sterilization are in the respective “off” modes. When the changeover switch 14 is on, the switch valves 10 and the heater 11 for sterilization are in the respective “on” modes.

Control signals are output from the control device 13 to an electric motor 7a configured to drive the pump 7, to the switch valves 10, to the heater 11 for sterilization, and to a container replacement lamp 13a.

The container replacement lamp 13a is a lamp for informing the user that the raw water container 4 is empty now, and is arranged at the front of the casing 1.

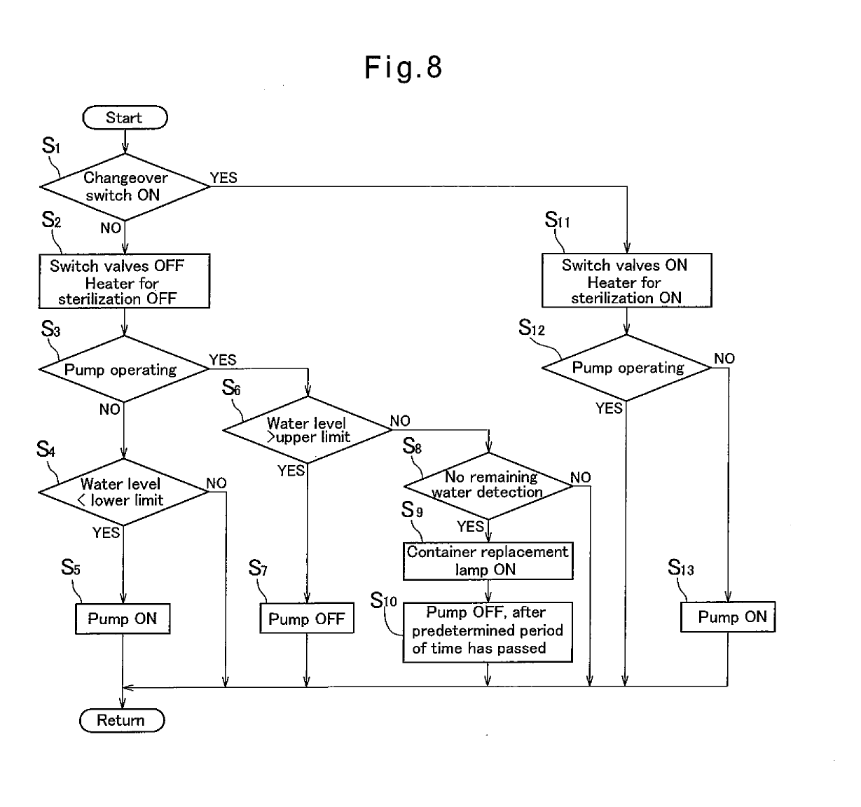

The water dispenser according to the embodiment is configured as described above. It is now described with reference to FIG. 8 and FIGS. 1, 3-6 how control is performed by the control device 13 of this water dispenser.

First, when the changeover switch 14 is turned off (step S1), the control device 13 turns off the switch valves 10 and the heater 11 for sterilization (step S2).

In this state, the upper and lower switch valves 10 allow communication between the raw water container 4 and the cold water tank 2 through the raw water supply line 6, while disconnecting the raw water supply line 6 from the circulation line 9, and the heater 11 for sterilization is not operating.

Second, in the state in which the pump 7 is not operating (step S3), when the water level sensor 2c detects that the water level of drinking water in the cold water tank 2 has fallen below a predetermined lower limit (step S4), the control device 13 activates the pump 7, so that drinking water is supplied by the pump 7 from the raw water container 4 to the cold water tank 2 (step S5).

In the state in which the pump 7 is operating (step S3), when the water level sensor 2c detects that the water level of drinking water in the cold water tank 2 has exceeded a predetermined upper limit(step S6), the control device 13 stops the operation of the pump 7 (step S7).

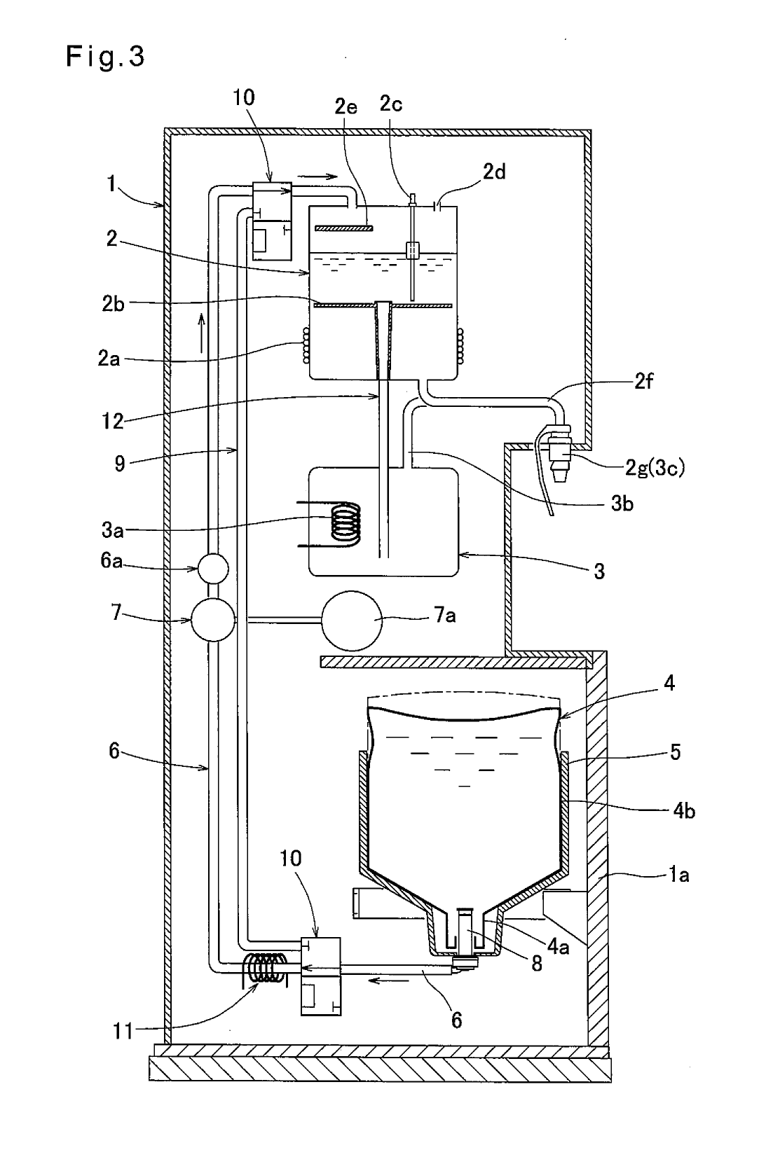

While, as illustrated in FIG. 3, a large amount of water remains in the container 4, as drinking water in the raw water container 4 is drawn up by the pump 7 and supplied to the cold water 2, the container 4 shrinks due to atmospheric pressure.

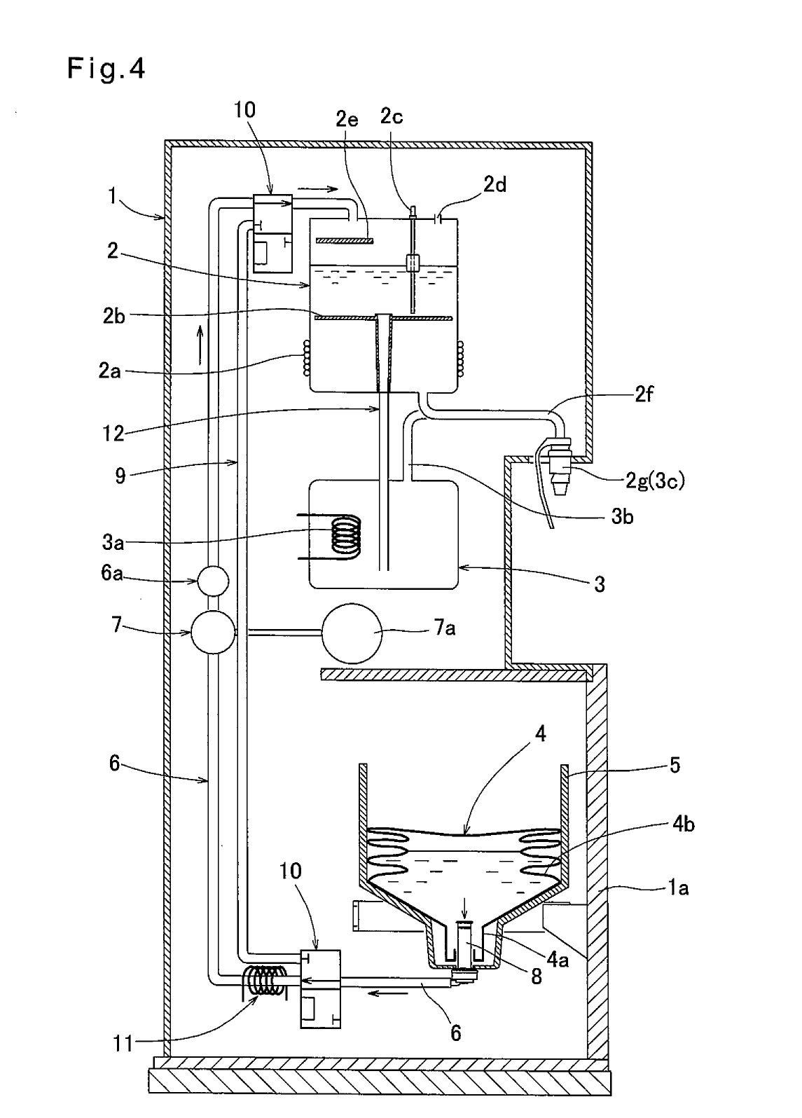

On the other hand, as illustrated in FIG. 4, when the amount of water remaining in the raw water container 4 decreases to a certain level, the container 4 is shrunk to such an extent that the container 4 is less likely to shrink further due to increased rigidity.

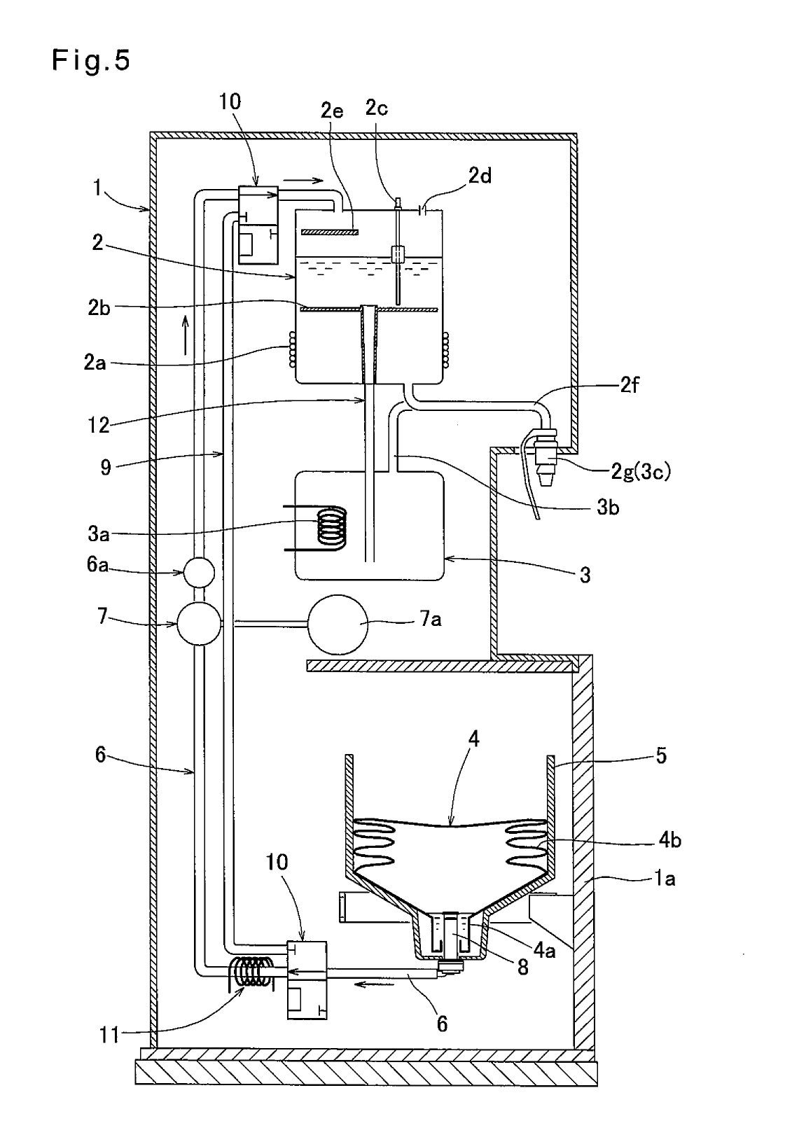

In the state in which the pump 7 is operating (step S3), when the flow sensor 6a detects that no drinking water is flowing in the raw water supply line 6 (step S8), as illustrated in FIG. 5, little drinking water is deemed to remain in the raw water container 4. Therefore, the control device 13 turns on the container replacement lamp 13a (step S9), and stops the operation of the pump 7 after a predetermined period of time has passed (step S10).

On the other hand, when the changeover switch 14 is turned on (step S1), the control device 13 turns on the switch valves 10 and the heater 11 for sterilization (step S11).

Namely at this time, communication is allowed between the raw water supply line 6 and the circulation line 9 by the upper and lower switch valves 10, while being blocked between the raw water container 4, the raw water supply line 6 and the cold water tank 2 by the valves 10, and the heater 11 for sterilization generates heat.

With the pump 7 operating (step S12), as illustrated in FIG. 6, water remaining in the raw water supply line 6 flows upwardly, flows into the circulation line 9 through the upper switch valve 10, flows downwardly in this circulation line 9 due to the pump 7, and flows into the line 6 again through the lower switch valve 10. In this way, water circulates between the raw water supply line 6 and the circulation line 9.

When water circulates between the raw water supply line 6 and the circulation line 9, the water is heated by the heater 11 for sterilization so as to reach sterilization temperature, i.e., temperature enough to kill normal germs (about 90 degrees Celsius). As a result thereof, the raw water supply line 6 is sterilized by hot water circulating in the line 6.

Also in this embodiment, the heater 11 for sterilization is arranged in the lower portion of the raw water supply line 6 in which water always remains, thus preventing the heater 11 from heating a portion of the line 6 where there is no water. Furthermore, since the upper and lower branch points at which the circulation line 9 branches off from the raw water supply line 6 are provided in the vicinity of the cold water tank 2 and the holder 5, respectively, hot water circulates in the substantially entire area of the line 6, thereby making it possible to sterilize a large area of the line 6.

In addition, since the interior of the joint member 8 and the portion of the raw water supply line 6 between the lower branch point and the joint member 8 are sterilized by the ultraviolet ray-emitting device 8d, mounted inside of the joint member 8, it is also possible to keep hygienic the portion of the line 6 in which hot water does not circulate. The ultraviolet ray-emitting device 8d may be always being turned on, or may be selectively turned on or turned off in synchronization with “on”/“off” mode of the heater 11 for sterilization.

While the switch valves 10 are in the sterilization operation position, the pump 7 and the heater 11 for sterilization may be stopped, after a predetermined period of time has passed by which time sufficient sterilization effect has been obtained.

On the other hand, when the pump 7 is not operating (step S12), the control device 13 activates the pump 7 (step S13), so that the raw water supply line 6 is sterilized by hot water in the same way as described above.

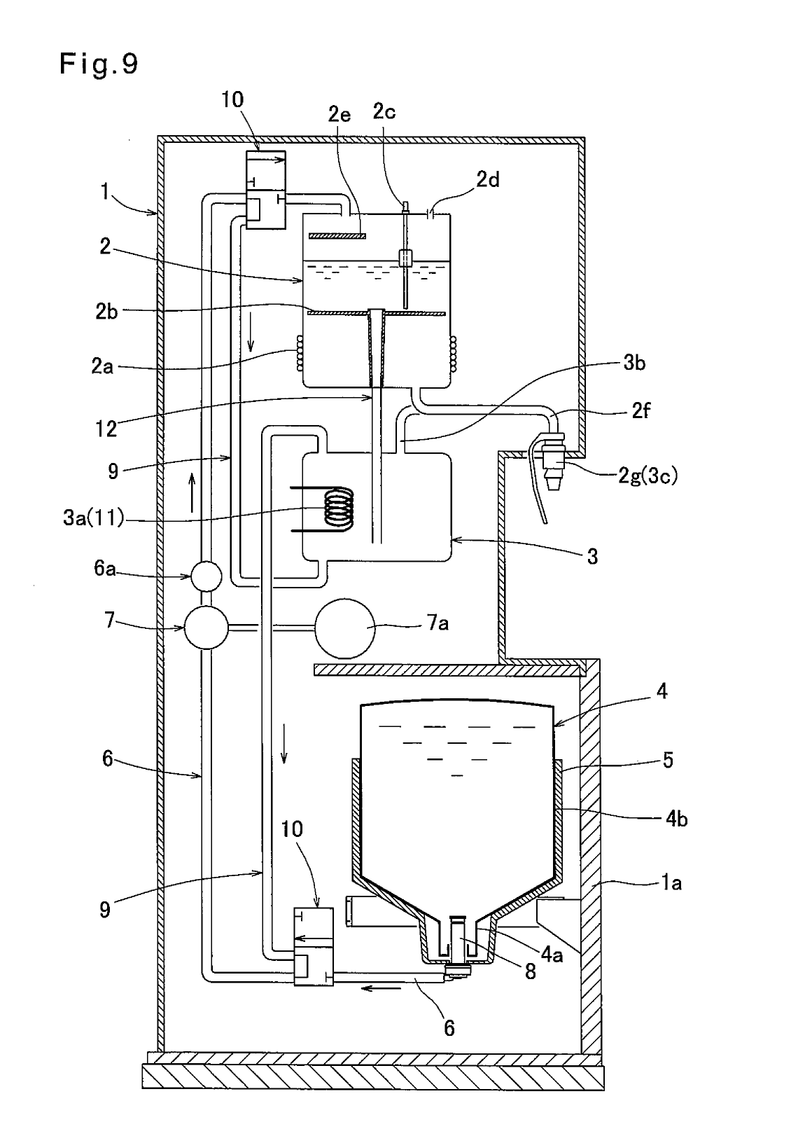

FIG. 9 illustrates a water dispenser according to another embodiment.

In this embodiment, the middle portion of the circulation line 9 is interrupted by the hot water tank 3. Namely, the circulation line 9 is divided into upper and lower half portions, and the bottom end of the upper half portion and the top end of the lower half portion are connected to the hot water tank 3.

In order to sterilize the raw water supply line 6 by hot water, the changeover switch 14 is turned on so as to move the upper and lower switch valves 10 to the sterilization operation position, and hot water stored in the hot water tank 3 and heated by the heater 3a is circulated by the pump 7 between the circulation line 9 and the raw water supply line 6.

Since the heater 3a for heating drinking water stored in the hot water tank 3 is also used as the heater 11 for sterilization in this way, it is not necessary to separately provide a heater for sterilization, and to control the heater for sterilization in synchronization with the switch valves 10. Therefore, it is possible to simplify the structure of the water dispenser.

In FIG. 9, the hot water tank 3 has a substantially columnar shape in its entirety as in general hot water tanks, and as for the outer surface of the tank 3, the tank 3 has disk-shaped top and bottom surfaces and a cylindrical circumferential surface. Also, the bottom end of the upper half portion of the circulation line 9 is connected to the bottom surface of the tank 3, and the top end of the lower half portion of the line 9 is connected to the top surface of the tank 3.

Therefore, hot water stored in the upper portion of the hot water tank 3 and having the highest temperature is sent by the pump 7 through the lower half portion of the circulation line 9 to the raw water supply line 6, water of which the temperature has fallen during its circulation returns through the upper half portion of the line 9 to the lower portion of the tank 3, and the water is heated again by the heater 3a so as to go up in the tank 3 and then sent to the line 9 again. Therefore, it is possible to keep high the temperature of hot water during its circulation.

Also, since the top and bottom surfaces of the hot water tank 3, to which the circulation line 9 is connected, are flat surfaces, the circulation line 9 can be easily connected to such top and bottom surfaces by e.g. welding, compared to connecting the line 9 to curved surfaces of the tank 3, to which it is more difficult to connect the line 9 by e.g. welding. By connecting the circulation line 9 to such flat top and bottom surfaces, it is also possible to reduce the possibility of leakage of water out of the portions of the tank 3 to which the line 9 is connected, due to poor connection.

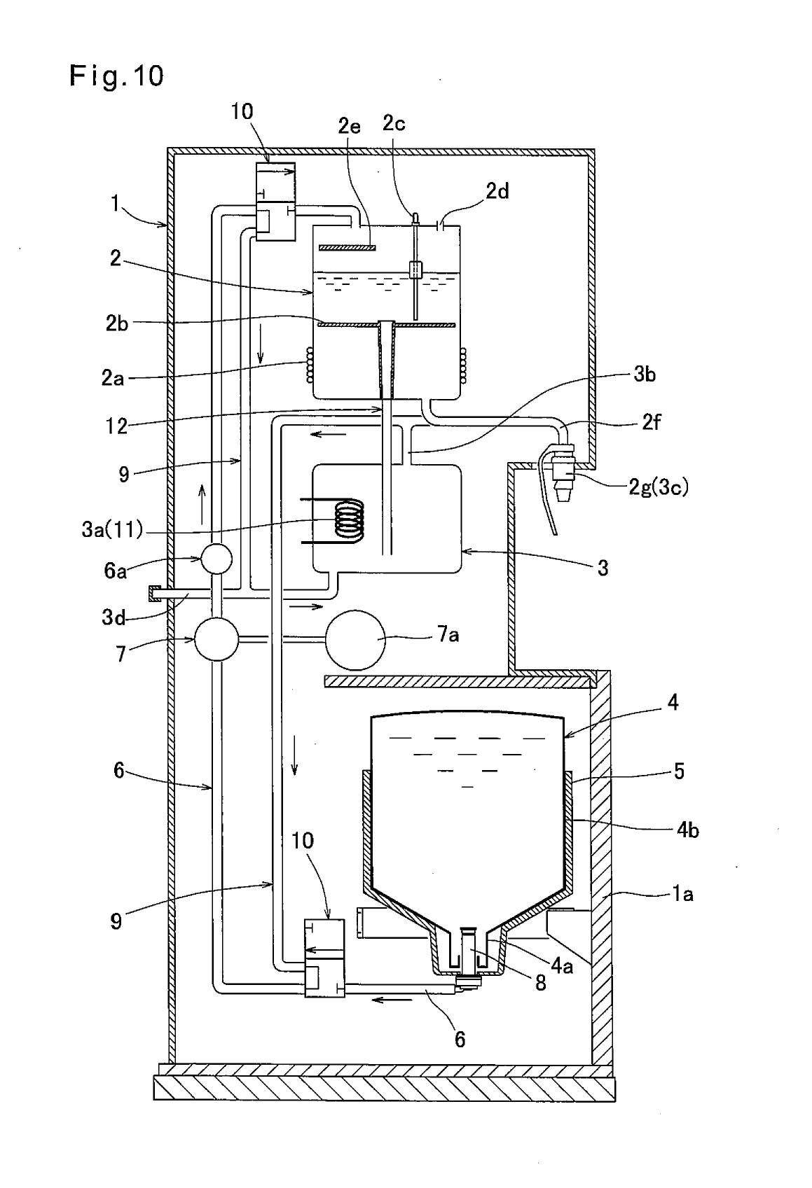

FIG. 10 illustrates a water dispenser according to another embodiment.

Though this embodiment is the same as the embodiment illustrated in FIG. 9 in that the middle portion of the circulation line 9 is interrupted by the hot water tank 3, and in that the line 9 is divided into upper and lower half portions, this embodiment is different from the embodiment illustrated in FIG. 9 in that the end portions of the line 9 are not directly connected to the tank 3.

Namely, the bottom end of the upper half portion of the circulation line 9 is connected to an intermediate portion of a drain discharge line 3d substantially horizontally extending from the bottom surface of the hot water tank 3 to the back side of the casing 1, and the top end of the lower half portion of the line 9 is connected to an intermediate portion of the hot water discharge line 3b, extending from the top surface of the tank 3 to the front side of the casing 1.

The drain discharge line 3d is a line provided for substantially completely discharging water remaining in the hot water tank 3 (drain) so as to make the tank 3 empty, when the water dispenser is not in use, for example, when the water dispenser is transported or stored.

This drain discharge line 3d is configured to be opened and closed by a known valve, etc. When the water dispenser is in use as described above, the drain discharge line 3d is closed by a valve, etc. and not used.

Since the hot water discharge line 3b is connected to the top surface of the hot water tank 3, only when the tank 3 is substantially filled with water, it is possible to discharge water stored in the tank 3 to the outside of the casing 1 through the line 3b. Therefore, when the water dispenser is not in use, it is impossible to use the hot water discharge line 3b so as to make the hot water tank 3 empty. However, in such a case, by opening the drain discharge line 3d, connected to the bottom surface of the hot water tank 3, by a valve, etc., substantially all water stored in the tank 3 is discharged from the bottom of the tank 3 to the outside of the casing 1 through the line 3d, thereby making it possible to make the tank 3 empty.

Needless to say, it is preferable to provide the drain discharge line 3d in each of the embodiments illustrated in FIGS. 1-8 and FIG. 9 as well. However, the drain discharge line 3d is not illustrated in these embodiments for convenience of explanation.

In order to sterilize the raw water supply line 6 by hot water, the upper and lower switch valves 10 are each moved to the sterilization operation position, and hot water stored in the hot water tank 3 and heated by the heater 3a is introduced through the hot water discharge line 3b into the lower half portion of the circulation line 9 which branches off from the line 3b, and further introduced from the lower half portion of the line 9 into the raw water supply line 6 through the switch valve 10 arranged at the lower branch point. Thereafter, hot water flowing upwardly in the raw water supply line 6 is introduced into the upper half portion of the circulation line 9 through the switch valve 10 arranged at the upper branch point, and returned from the upper half portion of the line 9 to the hot water tank 3 through the drain discharge line 3d.

In this way, hot water circulates between the circulation line 9 and the raw water supply line 6 through the hot water tank 3, the hot water discharge line 3b, and the drain discharge line 3d.

In the embodiment illustrated in FIG. 10, the bottom end of the upper half portion and the top end of the lower half portion of the circulation line 9 are connected to the drain discharge line 3d, extending from the hot water tank 3, and to the hot water discharge line 3b, respectively. Therefore, compared to directly connecting said bottom and top ends of the circulation line 9 to the hot water tank 3, the number of portions of the tank 3 to which respective lines are connected is small.

Namely, when the bottom end of the upper half portion and the top end of the lower half portion of the circulation line 9 are directly connected to the hot water tank 3, the number of the portions of the tank 3 to which respective lines are connected is five. Specifically, said bottom and top ends of the line 9, the hot water discharge line 3b, the drain discharge line 3d, and the tank connection line 12 are connected to the tank 3. On the other hand, in the embodiment illustrated in FIG. 10, the number of portions of the hot water tank 3 to which respective lines are connected is only three. Specifically, only the hot water discharge line 3b, the drain discharge line 3d, and the tank connection line 12 are connected to the tank 3.

The leakage of water is likely to occur due to poor welding, etc. at the portions of the hot water tank 3 to which respective lines are connected. Therefore, by reducing the number of portions of the hot water tank 3 to which respective lines are connected as described above, it is possible to reduce the likelihood that the leakage of water would occur.

The embodiments described herein are illustrative in all respects and not limitative. The scope of the present invention is indicated by the appended claims, and includes all modifications and variations within the scope of the claims and the meaning equivalent to the scope of the claims.

For example, though each of the above-described embodiments illustrates the raw water container 4, formed so as to shrink up to a predetermined limit as the amount of water remaining in the container 4 decreases, the present invention may be applied to a water dispenser including a rigid raw water container (so-called “hard bottle type”) of which the trunk portion does not shrink as the amount of water remaining in the container decreases. Such a rigid raw water container may be formed by blow molding of, for example, polyethylene terephthalate (PET) resin or polycarbonate (PC) resin.

Also, the present invention may be applied to a water dispenser including a raw water container flexibly formed so as to substantially shrink up to the limit as the amount of water remaining in the container decreases, so-called “bag type”, or including a raw water container constituted by a bag and a box in which the bag is received, so-called “bag-in box type”.

Furthermore, though each of the above-described embodiments illustrates only the state in which the raw water container 4 is held by the holder 5 with the mouth portion 4a of the container 4 directed downwardly, the present invention may be applied to a water dispenser in which the raw water container 4 is held by the holder 5 with the mouth portion 4a of the container 4 directed upwardly or in a lateral direction.

Also, the holder 5 is not limited to the structure illustrated in the figures, and it is sufficient that the holder 5 can hold the raw water container 4 in any manner, for example, by placing, supporting, or storing the container 4.

### DESCRIPTION OF REFERENCE NUMERALS

1: casing
1a: sliding member
2: cold water tank
2a: cooler
2b: baffle plate
2c: water level sensor
2d: air intake
2e: diffusing plate
2f: cold water discharge line
2g: cold water cock
3: hot water tank
3a: heater
3b: hot water discharge line
3c: hot water cock
3d: drain discharge line
4: raw water container
4a: mouth portion
4b: trunk portion
4c: cap
4d: valve
5: holder
5a: seal member
6: raw water supply line
6a: flow sensor
7: pump
7a: electric motor
8: joint member
8a: insertion portion
8b: base portion
8c: passage hole
8d: ultraviolet ray-emitting device
8e: connection portion
8f: flange
8g: mounting portion
9: circulation line
10: switch valve
11 heater for sterilization
12: tank connection line
13: control device
13a: container replacement lamp
14: changeover switch

1. A water dispenser comprising:
a holder configured to hold a replaceable raw water container filled with drinking water and including a mouth portion;
a cold water tank which is arranged at a higher level than the holder, and in which drinking water is cooled;
a raw water supply line extending between the holder and the cold water tank and including a tubular joint member provided at a bottom end portion of the raw water supply line, and configured to be inserted into the mouth portion 4a of the raw water container with the raw water container held by the holder such that an interior of the cold water tank communicates with an interior of the raw water container through the raw water supply line;
a pump attached to the raw water supply line;
a circulation line having a top end portion connected to an upper branch point of the raw water supply line in a vicinity of the cold water tank, and a bottom end portion connected to a lower branch point of the raw water supply line in a vicinity of the holder;
upper and lower switch valves provided at the upper and lower branch points, respectively, and movable between a normal operation position in which the raw water container and the cold water tank communicate with the raw water supply line, while the raw water supply line and the circulation line are disconnected from each other, and a sterilization operation position in which the raw water supply line communicates with the circulation line, while the raw water container and the cold water tank are disconnected from the raw water supply line; and
a heater for sterilization configured to heat water circulated by the pump between the raw water supply line and the circulation line until the water reaches a sterilization temperature, when the upper and lower valves are in the sterilization operation position.

2. The water dispenser according to claim 1, further comprising a hot water tank which is arranged at a higher level than the holder and at a lower level than the cold water tank, and to which a heater is attached which heats drinking water supplied from the cold water tank,
wherein the circulation line is interrupted by the hot water tank, and
wherein the heater attached to the hot water tank is used as the heater for sterilization.

3. The water dispenser according to claim 2, further comprising:
a hot water discharge line extending from a top portion of the hot water tank, and arranged such that only when the hot water tank is filled with water, water can be discharged from the hot water tank through the hot water discharge line; and
a drain discharge line extending from a bottom portion of the hot water tank, and configured to be opened and closed such that when the drain discharge line is opened, drinking water in the hot water tank can be completely discharged through the drain discharge line;
wherein the circulation line is divided into an upper half portion and a lower half portion, and
wherein a bottom end of the upper half portion is connected to the drain discharge line, and a top end of the lower half portion is connected to the hot water discharge line.

4. The water dispenser according to claim 1, further comprising a hot water tank which is arranged at a higher level than the holder and at a lower level than the cold water tank, and to which a heater is attached which heats drinking water supplied from the cold water tank,
wherein the circulation line is not connected to the hot water tank,
wherein the heater for sterilization is provided separately from the heater attached to the hot water tank at a portion of the raw water supply line between the upper and lower branch points or at a portion of the circulation line between the upper and lower branch points,
wherein the heater for sterilization is configured to generate heat when the upper and lower switch valves are in the sterilization operation position, and stop generating heat when the upper and lower switch valves are in the normal operation position.

5. The water dispenser according to claim 1, further comprising an ultraviolet ray-emitting device configured to apply an ultraviolet ray to an interior of the joint member of the raw water supply line so as to obtain sterilization effect.

6. The water dispenser according to claim 2, further comprising an ultraviolet ray-emitting device configured to apply an ultraviolet ray to an interior of the joint member of the raw water supply line so as to obtain sterilization effect.

7. The water dispenser according to claim 3, further comprising an ultraviolet ray-emitting device configured to apply an ultraviolet ray to an interior of the joint member of the raw water supply line so as to obtain sterilization effect.

8. The water dispenser according to claim 4, further comprising an ultraviolet ray-emitting device configured to apply an ultraviolet ray to an interior of the joint member of the raw water supply line so as to obtain sterilization effect.
